(19) United States
(12) Patent Application Publication
(10) Pub. No.: US 2003/0119688 A1
(43) Pub. Date: Jun. 26, 2003

(54) Organic paint stripper

(76) Inventors: Hans-Joergen Rehm, Hilden (DE); Brigitte Spei, Duesseldorf (DE)

Correspondence Address: HENKEL CORPORATION, 2500 RENAISSANCE BLVD, STE 200, GULPH MILLS, PA, 19406, US

(21) Appl. No.: 10/319,309

(22) Filed: Dec. 13, 2002

(30) Foreign Application Priority Data
Dec. 15, 2001 (DE) DE 10161846.8

(51) Int. Cl. C09D 9/00

(52) U.S. Cl. 510/201; 510/206; 510/505; 510/506

(57) ABSTRACT

The use of alkoxylated alkyl alcohols having 8 to 18 carbon atoms in the alkyl radical and with a total of 2 to 12 ethylene oxide and/or propylene oxide units per molecule as additive for paint stripper based on organic solvents, the paint stripper containing less than 5 wt. % of water; corresponding paint strippers based on alcoholic organic solvents; paint stripping process using these agents, particularly for non-ferrous metals.

### BACKGROUND OF THE INVENTION

1. Field of the Invention

The invention relates to an agent and a process for stripping lacquer from metal surfaces, particularly from metal surfaces made of non-ferrous metals such as aluminum or aluminum alloys. The main component of the organic paint stripper is an alcoholic organic solvent. A particularly good paint stripping effect is achieved due to the fact that the paint stripper contains, as an additional component, alkoxylated alkyl alcohols.

2. Prior Processes and Compositions

In production processes in which metallic components are lacquered, poorly lacquered parts and the mechanical devices used during the coating process, such as suspension tackle, regularly have to be stripped of lacquer. Organic paint strippers, for example, are available for this purpose. These are used in the temperature range from room temperature (so-called cold paint strippers) to about 120° C. (so-called hot paint strippers). Products introduced onto the market often contain various glycols, N-methylpyrrolidone as a product basis or, in older products, methylene chloride which has drawbacks in terms of toxicity. The active substances used are often benzyl alcohol, furfuryl alcohol and phenoxy ethanol and, in older products, methanol which is harmful to health. The paint strippers usually contain an alkali component such as alkali metal hydroxides or alkanolamines. In addition, they may contain additives such as corrosion inhibitors, thickeners, wetting agents, solubilisers and others.

There is a constant need on the market for products which can also be used for new, largely chemical-resistant lacquer systems which permit shorter paint stripping times and comply with present-day environmental standards. The object of the present invention is to improve products available hitherto in that respect.

The invention is based on the discovery that certain alkoxylated alkyl alcohols markedly improve the effect of previous paint strippers based on alcoholic organic solvents.

### SUMMARY OF THE INVENTION

In a first aspect, the invention relates to a paint stripper based on organic solvents which contains less than 5 wt. % of water and a total of 60 wt. % to 98 wt. % of alcoholic organic solvent and

c) a total of 1 wt. % to 20 wt. % of one or more alkoxylated alkyl alcohols having 8 to 18 carbon atoms in the alkyl radical and with a total of 2 to 12 ethylene oxide and/or propylene oxide units per molecule,

d) 1 wt. % to 10 wt. % of alkalizing agent selected from alkali metal hydroxides and alkanolamines, and if desired

e) 0.1 wt. % to 20 wt. % of further additives, the quantity proportions of the constituents adding up to 100 wt. %.

### DETAILED DESCRIPTION OF THE INVENTION

The term alcoholic organic solvent means a solvent which is liquid at room temperature and which contains one or more alcoholic OH groups. It may be alcohols, preferably with cyclic substituents, and (poly)glycols which may be etherified on one side. For example, the paint stripper may contain, as an alcoholic organic solvent, one or more glycol compounds selected from alkylene glycol, dialkylene glycol or trialkylene glycol having in each case 2 to 3 carbon atoms in each alkylene group and in each case monoethers hereof with alcohols having 1 to 5 carbon atoms. Preferred examples hereof include propyl, butyl or pentyl ethers of alkylene glycols, particularly of triethylene glycol.

In a particular embodiment, a mixture of two components is used as the alcoholic organic solvent, the one component being a glycol compound and the other component being an alcohol with a cyclic substituent. Accordingly, the invention relates particularly to a paint stripper which contains

a) a total of 50 wt. % to 80 wt. % of one or more glycol compounds selected from alkylene glycol, dialkylene glycol or trialkylene glycol having in each case 2 to 3 carbon atoms in each alkylene group and in each case monoethers hereof with alcohols having 1 to 5 carbon atoms,

b) a total of 10 wt. % to 30 wt. % of one or more alcohols bearing at least one saturated or unsaturated or aromatic homo- or heterocyclic cyclic substituent,

c) a total of 1 wt. % to 20 wt. % of one or more alkoxylated alkyl alcohols having 8 to 18 carbon atoms in the alkyl radical and with a total of 2 to 12 ethylene oxide and/or propylene oxide units per molecule,

d) 1 wt. % to 10 wt. % of alkalizing agent selected from alkali metal hydroxides and alkanolamines, and if desired

e) 0.1 wt. % to 20 wt. % of further additives, the quantity proportions of the constituents adding up to 100 wt. %.

The alcohol b) is preferably selected from benzyl alcohol, furfuryl alcohol and phenoxy ethanol. The glycol compound

a) is in turn selected preferably from monoethers of alkylene glycols, particularly of trialkylene glycol with alcohols having 3 to 5 carbon atoms. For example, triethylene glycol butyl ether may be used, the etherified butyl alcohol possibly being present as a primary, secondary or tertiary alcohol.

Generally, for the purposes of the present invention, the alkoxylated alkyl alcohol(s) c) are preferably selected from ethoxylation products of linear primary alkyl alcohols having 8 to 12 carbon atoms in the alkyl radical with 2 to 12 ethylene oxide units. The degree of ethoxylation is preferably in the range from 2 to 8, particularly in the range from 2.5 to 6.

The additives e), if present, may be selected from corrosion inhibitors, wetting agents, thickeners and solubilisers. Particularly suitable corrosion inhibitors are those known to be effective for non-ferrous metals. Examples include triazines for use on ferrous metals or carboxylic acids having 6 to 11 carbon atoms, for example, octanoic acid, or octylphosphonic acid for use on aluminum or aluminum alloys.

Apart from the components already enumerated, the paint stripper may contain further constituents. This is not, however, necessary in practice. The invention relates, therefore, particularly to a paint stripper comprising

a) a total of 50 wt. % to 80 wt. % of one or more glycol compounds selected from alkylene glycol, dialkylene glycol and trialkylene glycol having in each case 2 or 3 carbon atoms in each alkylene group and in each case monoethers hereof with alcohols having 1 to 5 carbon atoms,

b) a total of 10 wt. % to 30 wt. % of one or more alcohols bearing at least one saturated or unsaturated or aromatic homo- or heterocyclic cyclic substituent,

c) a total of 1 wt. % to 20 wt. % of one or more alkoxylated alkyl alcohols having 8 to 18 carbon atoms in the alkyl radical and with a total of 2 to 12 ethylene oxide and/or propylene oxide units per molecule,

d) 1 wt. % to 10 wt. % of alkalizing agent selected from alkali metal hydroxides and alkanolamines, and if desired

e) 0.1 wt. % to 20 wt. % of further additives, the quantity proportions of the constituents adding up to 100 wt. %.

The additives e) are not necessary in every case either. Rather, the paint stripper may also comprise substantially the four components a) to d). Accordingly, the invention also relates to a paint stripper comprising substantially

a) a total of 50 wt. % to 80 wt. % of one or more glycol compounds selected from alkylene glycol, dialkylene glycol and trialkylene glycol having, in each case, 2 to 3 carbon atoms in each alkylene group and in each case monoethers hereof with alcohols having 1 to 5 carbon atoms,

b) a total of 10 wt. % to 30 wt. % of one or more alcohols bearing at least one saturated or unsaturated or aromatic homo- or heterocyclic cyclic substituent,

c) a total of 1 wt. % to 20 wt. % of one or more alkoxylated alkyl alcohols having 8 to 18 carbon atoms in the alkyl radical and with a total of 2 to 12 ethylene oxide and/or propylene oxide units per molecule,

d) 1 wt. % to 10 wt. % of alkalizing agent selected from alkali metal hydroxides and alkanolamines, the quantity proportions adding up to 100 wt. %.

It is not, however, necessary in this case for the paint stripper to contain the two different alcoholic organic solvents a) and b). Rather, the invention also relates to a paint stripper comprising a total of 60 wt. % to 98 wt. % of alcoholic organic solvent and

c) a total of 1 wt. % to 20 wt. % of one or more alkoxylated alkyl alcohols having 8 to 18 carbon atoms in the alkyl radical and with a total of 2 to 12 ethylene oxide and/or propylene oxide units per molecule,

d) 1 wt. % to 10 wt. % of alkalizing agent selected from alkali metal hydroxides and alkanolamines, and if desired

e) 0.1 wt. % to 20 wt. % of further additives, the quantity proportions of the constituents adding up to 100 wt. %.

The alcoholic organic solvent, as described further herein, is preferably an alkyl ether of an alkylene glycol, particularly of an alkylene triglycol. Propyl, butyl or pentyl ethers of triethylene glycol are particularly preferred. The additives (e) are not absolutely necessary, so the paint stripper may comprise substantially the alcoholic organic solvent and the components c) and d).

In a further aspect, the invention relates to the use of the paint strippers described herein for stripping lacquered components made of non-ferrous metals, particularly aluminum or aluminum alloys composed of not more than 50 atom % aluminum.

Moreover, the invention relates to a process for stripping lacquer from components made of non-ferrous metals, particularly aluminum or aluminum alloys composed of not more than 50 atom % aluminum, the components being brought into contact with one of the paint strippers described above which has a temperature from 20° C. to 130° C., preferably from 40° C. to 90° C. The period of time until complete paint stripping depends on the lacquer type, the active substance concentration in the paint stripper and on the temperature thereof. It may be from a few minutes, for example, 5 minutes to several hours, for example 10 hours.

The invention is based, therefore, on the fact that, due to the addition of the alkoxylated alkyl alcohols described, the effect of conventional organic paint strippers may be markedly increased. This permits reduced paint stripping cycles and hence reduced production cycles. The invention relates, therefore, in its most general aspect, to the use of alkoxylated alkyl alcohols having 8 to 18 carbon atoms in the alkyl radical and with a total of 2 to 12 ethylene oxide and/or propylene oxide units per molecule as additive for paint stripper based on organic solvents, the paint stripper containing less than 5 wt. % of water. The alkoxylated alkyl alcohols used, even from this broad aspect, are preferably those which were described in more detail above in connection with the various aspects of the invention.

### EXAMPLES

Lacquered aluminum strips which were coated with an acrylate powder coating with a layer thickness of about 120 μm were used for testing the paint stripping effect. The parts were immersed without movement in the paint stripper which had a temperature of 70° C. In some cases, uncut original parts were used for the paint stripping tests and in some cases the parts were cut into strips about 5 cm wide. This affects the paint stripping effect. Appropriate details and paint stripping times are contained in the Table.

The following comparison mixtures V1 and V2 and mixtures according to the invention B1 and B2 were used for the tests. The compositions are given in wt. %.

V1 (comparison example, commercial product)

| | |
|---|---|
| Butyl glycol | 56 |
| N-methylpyrrolidone | 35 |
| Monoethanolamine | 7.5 |
| KOH flakes | 1.5 |

V2 (comparison example)

| | |
|---|---|
| Butyl triglycol | 75 |
| Benzyl alcohol | 20 |
| KOH flakes | 5 |

B1 (according to the invention)

| | |
|---|---|
| Butyl triglycol | 96 |
| KOH flakes | 2 |
| n-Octanol × 4 ethylene oxide | 2 |

B2 (according to the invention)

| | |
|---|---|
| Butyl triglycol | 70 |
| Benzyl alcohol | 20 |
| KOH flakes | 5 |
| n-Octanol × 4 ethylene oxide | 5 |

| | | Paint stripping | % stripped |
|---|---|---|---|
| Paint stripper | Parts cut? | time (minutes) | surface |
| V1 | Yes | 15 | 50 |
| B1 | Yes | 15 | 75 |
| V1 | No | 25 | 5 |
| B1 | No | 25 | 95 |
| V2 | Yes | 20 | 0 |
| B2 | Yes | 20 | 90-98 |

What is claimed is:

1. Paint stripper based on organic solvents which contains less than 5 wt. % of water and a total of 60 wt. % to 98 wt. % of alcoholic organic solvent and
c) a total of 1 wt. % to 20 wt. % of one or more alkoxylated alkyl alcohols having 8 to 18 carbon atoms in the alkyl radical and with a total of 2 to 12 ethylene oxide and/or propylene oxide units per molecule,
d) 1 wt. % to 10 wt. % of alkalizing agent selected from alkali metal hydroxides and alkanolamines, and if desired
e) 0.1 wt. % to 20 wt. % of further additives, the quantity proportions of the constituents adding up to 100 wt. %.

2. Paint stripper according to claim 1, characterized in that it contains, as alcoholic organic solvent,
a) one or more glycol compounds selected from alkylene glycol, dialkylene glycol and trialkylene glycol having in each case 2 to 3 carbon atoms in each alkylene group and in each case monoethers thereof with alcohols having 1 to 5 carbon atoms.

3. Paint stripper according to claim 1, characterized in that it contains
a) a total of 50 wt. % to 80 wt. % of one or more glycol compounds selected from alkylene glycol, dialkylene glycol or trialkylene glycol having in each case 2 to 3 carbon atoms in each alkylene group and in each case monoethers hereof with alcohols having 1 to 5 carbon atoms,
b) a total of 10 wt. % to 30 wt. % of one or more alcohols bearing at least one saturated or unsaturated or aromatic homo- or heterocyclic cyclic substituents,
c) a total of 1 wt. % to 20 wt. % of one or more alkoxylated alkyl alcohols having 8 to 18 carbon atoms in the alkyl radical and with a total of 2 to 12 ethylene oxide and/or propylene oxide units per molecule,
d) 1 wt. % to 10 wt. % of alkalizing agent selected from alkali metal hydroxides and alkanolamines, and if desired
e) 0.1 wt. % to 20 wt. % of further additives, the quantity proportions of the constituents adding up to 100 wt. %.

4. Paint stripper according to claim 3, characterized in that the alcohol b) is selected from benzyl alcohol, furfuryl alcohol and phenoxy ethanol.

5. Paint stripper according to one or more of claims 2 to 4, characterized in that it contains one or more glycol compounds a) which are selected from trialkylene glycol monoether with alcohols having 3 to 5 carbon atoms.

6. Paint stripper according to one or more of claims 1 to 5, characterized in that the alkoxylated alkyl alcohol(s) c) are selected from ethoxylation products of linear primary alkyl alcohols having 8 to 12 carbon atoms in the alkyl radical with 2 to 12 ethylene oxide units.

7. Paint stripper according to one or more of claims 1 to 6, characterized in that the further additives e) are selected from corrosion inhibitors, wetting agents, thickeners and solubilisers.

8. Paint stripper according to one or more of claims 3 to 7, characterized in that it comprises
a) a total of 50 wt. % to 80 wt. % of one or more glycol compounds selected from alkylene glycol, dialkylene glycol and trialkylene glycol in each case having 2 to 3 carbon atoms in each alkylene group and in each case monoethers hereof with alcohols having 1 to 5 carbon atoms,
b) a total of 10 wt. % to 30 wt. % of one or more alcohols bearing at least one saturated or unsaturated or aromatic homo- or heterocyclic cyclic substituent,
c) a total of 1 wt. % to 20 wt. % of one or more alkoxylated alkyl alcohols having 8 to 18 carbon atoms in the alkyl radical and with a total of 2 to 12 ethylene oxide and/or propylene oxide units per molecule,
d) 1 wt. % to 10 wt. % of alkalizing agent selected from alkali metal hydroxides and alkanolamines, and if desired
e) 0.1 wt. % to 20 wt. % of further additives, the quantity proportions of the constituents adding up to 100 wt. %.

9. Paint stripper according to one or more of claims 3 to 6, characterized in that it comprises
a) a total of 50 wt. % to 80 wt. % of one or more glycol compounds selected from alkylene glycol, dialkylene glycol or trialkylene glycol in each case having 2 to 3 carbon atoms in each alkylene group and in each case monoethers hereof with alcohols having 1 to 5 carbon atoms,
b) a total of 10 wt. % to 30 wt. % of one or more alcohols bearing at least one saturated or unsaturated or aromatic homo- or heterocyclic cyclic substituent,
c) a total of 1 wt. % to 20 wt. % of one or more alkoxylated alkyl alcohols having 8 to 18 carbon atoms in the alkyl radical and with a total of 2 to 12 ethylene oxide and/or propylene oxide units per molecule,
d) 1 wt. % to 10 wt. % of alkalizing agent selected from alkali metal hydroxides and alkanolamines, the quantity proportions of the constituents adding up to 100 wt. %.

10. Paint stripper according to one or both of claims 1 and 2, characterized in that it comprises a total of 60 wt. % to 98 wt. % of alcoholic organic solvent and
c) a total of 1 wt. % to 20 wt. % of one or more alkoxylated alkyl alcohols having 8 to 18 carbon atoms in the alkyl radical and with a total of 2 to 12 ethylene oxide and/or propylene oxide units per molecule,
d) 1 wt. % to 10 wt. % of alkalizing agent selected from alkali metal hydroxides and alkanolamines, and if desired
e) 0.1 wt. % to 20 wt. % of further additives, the quantity proportions of the constituents adding up to 100 wt. %.

11. The use of a paint stripper according to one or more of claims 1 to 10 for stripping lacquered components made of non-ferrous metals, particularly aluminum or aluminum alloys composed of more than 50 atom % aluminum.

12. A process for stripping lacquer from components made of non-ferrous metals, particularly aluminum or aluminum alloys composed of not more than 50 atom % aluminum, the components being brought into contact with a paint stripper according to one or more of claims 1 to 10 which has a temperature from 20° C. to 130° C., preferably from 40° C. to 90° C.

13. The use of alkoxylated alkyl alcohols having 8 to 18 carbon atoms in the alkyl radical and with a total of 2 to 12 ethylene oxide and/or propylene oxide units per molecule as additive for paint stripper based on organic solvents, the paint stripping agent containing less than 5 wt. % of water.
